(19) United States
(12) Patent Application Publication
(10) Pub. No.: US 2025/0267116 A1
(43) Pub. Date: Aug. 21, 2025

(54) INTELLIGENT CHANNEL MODERATION BOT (ICMBOT) INTEGRATED IN CONVERSATION PLATFORM

(71) Applicant: INTERNATIONAL BUSINESS MACHINES CORPORATION, ARMONK, NY (US)

(72) Inventors: Jun Su, Beijing (CN); Su Liu, Austin, TX (US); Diane Basara Britton, Poughkeepsie, NY (US); Fan Yang, Beijing (CN)

(21) Appl. No.: 18/443,260

(22) Filed: Feb. 15, 2024

(51) Int. Cl. H04L 51/216; G06F 40/40

(52) U.S. Cl. CPC H04L 51/216; G06F 40/40

(57) ABSTRACT

A computer-implemented method for managing posts in a conversation platform includes receiving a post, posted by a user to a first conversational channel, into an intelligent channel moderation bot (ICMBot) screener of an ICMBot server. The content of the post is analyzed and one or more channels related to the content of the post are determined. A best-fit conversation channel is found from the determined one or more channels. The post is retained in the best-fit conversational channel when the first conversational channel is the best-fit conversational channel or the post is routed from the first conversational channel into the best-fit conversational channel when the first conversation channel is not the best-fit conversational channel.

### BACKGROUND

The present disclosure generally relates to systems and methods for managing posts in a conversation platform, and more particularly, to an intelligent channel moderation bot (ICMBot) that can be integrated into a conversation platform for finding and routing posts to a best-fit channel of the conversation platform.

Intent analysis is very important and useful to help users to find a right resources. Conversational channels and conversation platforms are essential for modern companies because they foster efficient communication, support remote collaboration, promote knowledge sharing, encourage cross-functional teamwork, and enable agile decision-making. These platforms contribute to overall productivity, customer engagement, and employee satisfaction, making them a critical aspect of modern business operations.

Such conversational channels and conversation platforms are useful due to the following reasons: (a) Efficient Communication. Conversational channels and platforms enable real-time and asynchronous communication among team members, departments, and even external stakeholders. This allows for quick information sharing, collaboration, and decision-making, leading to improved efficiency in business operations; (b) Remote Collaboration. With the rise of remote and distributed teams, conversational channels provide a central space for team members to connect and work together regardless of their physical locations. This fosters seamless collaboration, even in a remote work environment; (c) Knowledge Sharing. Conversation platforms serve as repositories of knowledge, where employees can share insights, best practices, and important updates. This democratizes access to information, empowering all team members to stay informed and make better decisions; (d) Cross-Functional Communication. Conversational channels break down silos within an organization, enabling communication and collaboration across different departments and teams. This encourages cross-functional cooperation and a more holistic approach to problem-solving; (e) Document Sharing and Collaboration. Conversational channels often integrate with document-sharing and collaboration tools, allowing teams to co-author documents, share files, and provide feedback within the same platform; (f) Historical Record. Conversational channels create a historical record of discussions and decisions, making it easier for team members to refer back to previous conversations and track the progress of projects; and (g) Employee Engagement. Modern employees value communication tools that are intuitive and resemble familiar messaging apps. By providing a conversational platform, companies can increase employee engagement and satisfaction.

### SUMMARY

In one embodiment, a system and method are described for managing posts in a conversation platform that can address the misplacement and disorganization of posts. An Intelligent Channel Moderation Bot, the ICMBot, can be seamlessly integrated into an existing conversation platform and to provide several features, including utilizing advanced natural language processing (NLP) and artificial intelligence (AI) techniques to analyze the content of user posts, understand their intent, and categorize them into relevant topics. The ICMBot can detect whether a user's post contains improper information and/or topic in a current conversation channel and can route the post to a proper conversation channel to ensure that the post can reach the appropriate audience for facilitating efficient communication.

In one embodiment, a computer implemented method and a computer program product can be configured for managing posts in a conversation platform includes receiving a post, posted by a user to a first conversational channel, into an intelligent channel moderation bot (ICMBot) screener of an ICMBot server. The content of the post is analyzed and one or more channels related to the content of the post are determined. A best-fit conversation channel is found from the determined one or more channels. The post is retained in the best-fit conversational channel when the first conversational channel is the best-fit conversational channel or the post is routed from the first conversational channel into the best-fit conversational channel when the first conversation channel is not the best-fit conversational channel.

In another embodiment, a computer-implemented method for managing posts in a conversation platform includes receiving, into an intelligent channel moderation bot (ICMBot) screener, a post content from an input buffer manager of a user in real time while the user is creating the post. The content of the post is analyzed and one or more channels related to the content of the post are determined. A best-fit conversation channel is found from the determined one or more channels and the best-fit conversation channel is recommended to the user prior to the user posting the post into the conversation platform.

In another embodiment, a system includes a processor; a data bus coupled to the processor; a memory coupled to the data bus; and a computer-usable medium embodying a computer program code, the computer program code comprising instructions executable by the processor. The computer program code is configured to receive a post that is either (1) an already-posed post posted by a user to a first conversational channel, or (2) a pre-posed post based on content from an input buffer manager of a user in real time while the user is creating the post, into an intelligent channel moderation bot (ICMBot) screener of an ICMBot server. The computer program code can analyze content of the post, determine one or more channels related to the content of the post, and find a best-fit conversation channel from the determined one or more channels. For the already-posted post, the computer program code can retain the already-posted post in the best-fit conversational channel when the first conversational channel is the best-fit conversational channel or route the already-posted post from the first conversational channel into the best-fit conversational channel when the first conversation channel is not the best-fit conversational channel. For the pre-posted post, the computer program code can recommend the best-fit conversation channel to the user prior to the user posting the pre-posted post into the conversation platform.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a pictorial representation of components of an intelligent channel moderation bot (ICMBot), consistent with an illustrative embodiment;

FIG. 2A shows a flow chart showing the interconnection of the components of the ICMBot of FIG. 1 with a conventional conversational application client, consistent with an illustrative embodiment;

FIG. 2B shows a flow chart showing the interconnection of the components of the ICMBot of FIG. 1 with a conversational application client that includes features of the ICMBot integrated therewith, consistent with an illustrative embodiment;

FIG. 3 shows a flow chart illustrating an overall process for managing posts in a conversation platform, consistent with an illustrative embodiment;

FIG. 4 shows a flow chart illustrating an overall process for managing posts in a conversation platform, consistent with an illustrative embodiment; and

FIG. 5 is a functional block diagram illustration of a computer hardware platform that can be used to implement the method for managing posts in a conversation platform, consistent with an illustrative embodiment.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide systems and methods that can provide an intelligent channel moderation bot (ICMBot) integrated in a conversation platform for (1) analyzing and learning the content of users' posts; (2) understanding the post intent; (3) categorizing the post into relevant topics; (4) identifying whether a user's post includes improper information and/or topic in the current conversation channel; (5) finding the best-fit conversational channel; and (6) routing the user's post to a best-fit conversation channel.

As discussed in greater detail below, the method can include (1) defining a framework to support the new feature of the ICMBot; (2) defining a data structure to track ICMBot related parameters in real time; (3) defining ICMBot criteria; (4) allowing administrators and users to configure and adjust the ICMBot settings; (5) learning categories of existing and newly created channels (private and/or public) from posted content, purpose descriptions of the channels, and other users' reactions; (6) monitoring a user's editing buffer when the user is inputting in client side; (7) identifying the intent of users' inputs in real-time and concluding the topic of the input; (8) mapping the best fit conversation channel according to the identified users' intents and inputted topics; (9) suggesting the mapped conversation channels to deliver the users' message to the mapped channels; (10) screening the posts posted contents and others' reactions in multiple conversation channels; calculating an on-topic score according matched keywords in metadata of each channel for each screened message; (11) routing the off-topic messages to the mapped conversation channels with highest on-topic score and notifying the user and related parties; and (12) adjusting the ICMBot settings and criteria according to users' feedback and percentage of the off-topic messages.

According to an aspect of the present disclosure, there is provided a computer-implemented method, a system and a computer program product for managing posts in a conversation platform, where the method includes computer-implemented method for managing posts in a conversation platform including receiving a post, posted by a user to a first conversational channel, into an intelligent channel moderation bot (ICMBot) screener of an ICMBot server and analyzing content of the post. The computer-implemented method can determine one or more channels related to the content of the post and find a best-fit conversation channel from the determined one or more channels. The computer-implemented method can retain the post in the best-fit conversational channel when the first conversational channel is the best-fit conversational channel or route the post from the first conversational channel into the best-fit conversational channel when the first conversation channel is not the best-fit conversational channel.

In an embodiment, which can be combined with the preceding embodiment, the method further includes periodically receiving the post or a plurality of new posts, posted by the user to one or more conversational channels, into the ICMBot screener.

In an embodiment, which can be combined with one or more of the preceding embodiments, the method further includes determining an intent of the post by analyzing keywords and information provided in the post to determine which category or channel the post belongs.

In an embodiment, which can be combined with one or more of the preceding embodiments, the method further includes calculating an on-topic score according matched keywords between metadata of each conversational channel and the post.

In an embodiment, which can be combined with one or more of the preceding embodiments, the method further includes routing, when the post is determined to be off-topic, the post to a mapped conversation channels having a highest on-topic score.

In an embodiment, which can be combined with one or more of the preceding embodiments, the method further includes notifying the user of the post being routed to the mapped conversation channel.

In an embodiment, which can be combined with one or more of the preceding embodiments, the method further includes adjusting settings and criteria of the ICMBot server according to users' feedback and values of off-topic and on-topic posts.

In an embodiment, which can be combined with one or more of the preceding embodiments, the method further includes learning categories of existing and newly created channels from posted content, purpose descriptions of conversational channels, and reaction of other users.

In an embodiment, which can be combined with one or more of the preceding embodiments, the method further includes screening content and other users' reactions in multiple ones of a plurality of conversational channels.

In an embodiment, which can be combined with one or more of the preceding embodiments, the method further includes receiving an input from administrators and users to configure and adjust settings and criteria of the ICMBot server.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may manage posts in a conversation platform. This may have the technical effect of either (1) automatically, in real-time during post creation, suggest an appropriate conversation platform channel for the post, or (2) reviewing posted messages to ensure such posts are in an appropriate conversation platform, where, in either event, the data of the conversation platform is improved without requiring constant user monitoring and/or review, where such review may be impossible for large conversation platforms. Accordingly, the system and methods according to aspects of the present disclosure provide a substantial improvement to technology and computer functionality.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

Aspects of the present disclosure can provide systems and methods for managing posts in a conversation system. The conversation system can include a plurality of channels in a wide range of categories. Such channels can include, as representative examples, (1) general discussion channels focused on general discussions, watercooler talk, and casual interactions among team members; (2) announcement channels dedicated to important company-wide announcements, news updates, and official communications; (3) project collaboration channels centered around specific projects or initiatives, where team members can discuss progress, share updates, and coordinate tasks; (4) technical support channels for addressing technical issues, troubleshooting, and seeking help from colleagues or support teams; (5) knowledge sharing channels for sharing industry insights, best practices, articles, and resources related to a particular field or topic; (6) feedback and idea channels where team members can provide feedback, share ideas for improvement, and contribute to brainstorming sessions; (7) events and activities channels for planning and discussing upcoming events, team outings, workshops, and social activities; (8) job opening channels dedicated to sharing job openings, career opportunities, and recruitment-related discussions; (9) customer support channels for interacting with customers, answering inquiries, providing support, and resolving issues; (10) sales and marketing channels focused on sales strategies, marketing campaigns, lead generation, and customer engagement; (11) product development channels for discussing product features, roadmaps, user feedback, and development progress; (12) diversity and inclusion channels for promoting diversity, equity, and inclusion discussions, sharing resources, and raising awareness; (13) training and onboarding channels for new employee onboarding, training sessions, and sharing training materials; (14) industry trend channels focused on discussing emerging trends, innovations, and market developments within a specific industry; (15) regional or location-based channels catering to specific regions or locations, facilitating local discussions, news, and events; (16) leadership update channels for leadership to communicate strategic updates, organizational changes, and long-term goals; (17) health and wellness channels dedicated to promoting well-being, health tips, mindfulness, and fitness challenges; (18) remote work tip channels providing advice, tools, and best practices for effective remote work; (19) book club or learning channels for discussing books, articles, and other educational content, fostering a culture of continuous learning; and (20) fun and entertainment channels for sharing jokes, memes, and light-hearted content to boost team morale. Of course, this list is not exhaustive and different and/or other channels may be provided. Given the potential for a large number of channels serving a large number of users, aspects of the present disclosure can assist the user by assuring their post ends up in the proper channel, as described in greater detail below.

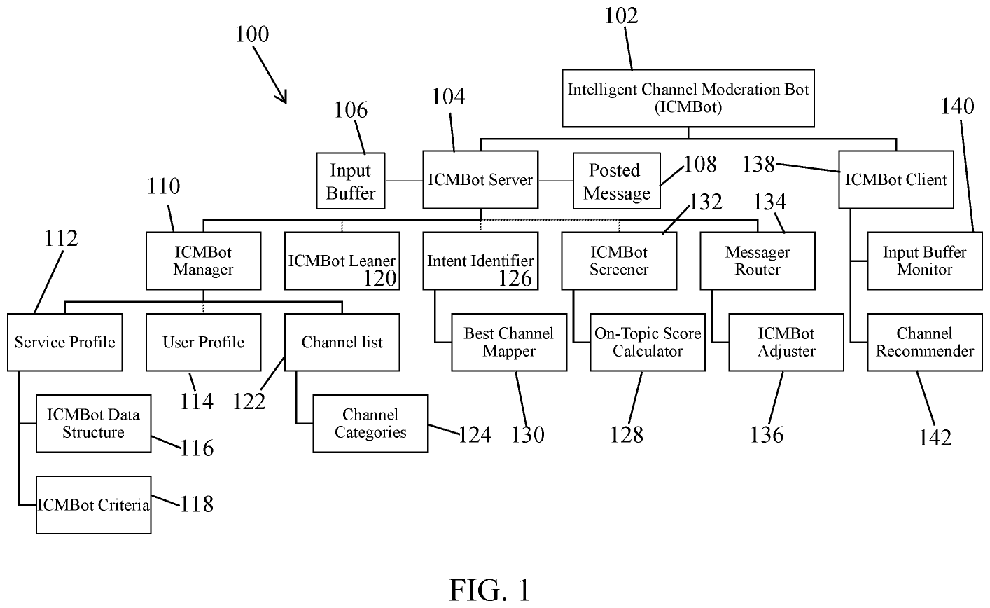

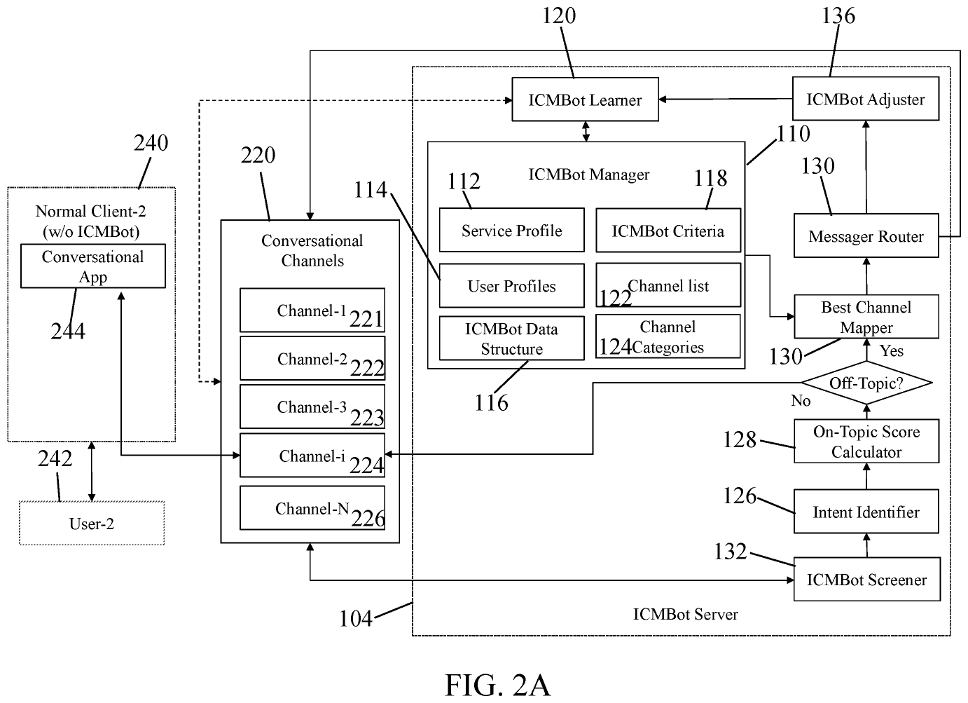

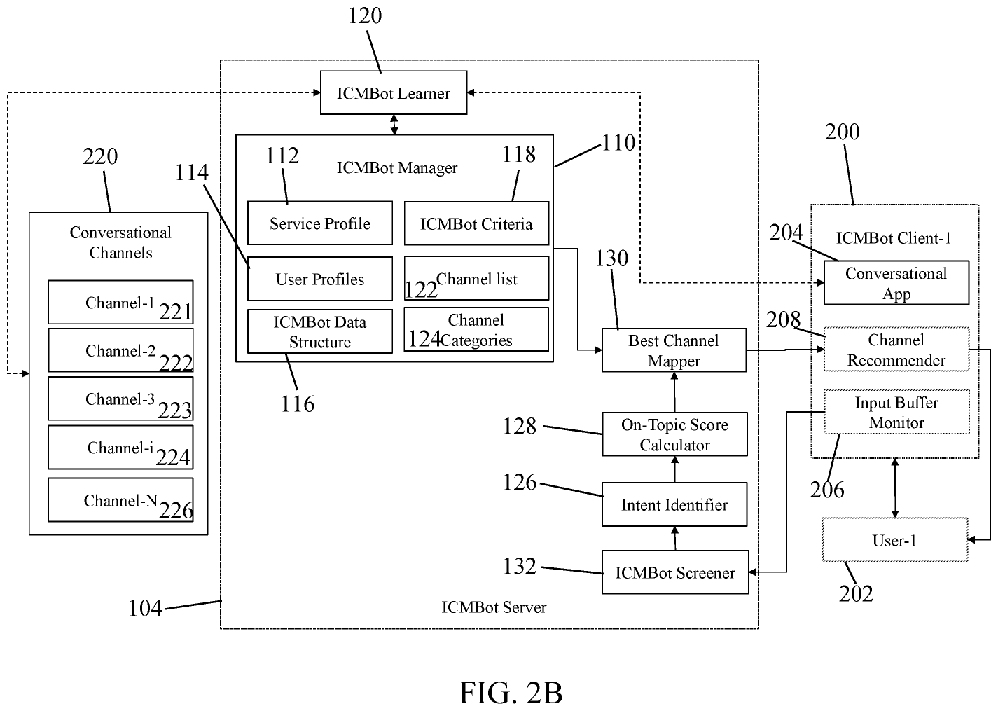

Referring to FIG. 1, an intelligent channel moderation bot (ICMBot) 102 can include a ICMBot framework 100 that provides the infrastructure and functionality to support the ICMBot features. The framework 100 can include an ICMBot server 104 that can be a server in a cloud environment, an edge computing environment, or embedded into one network connected local device, for example. As discussed below in conjunction with the flow charts of FIGS. 2A and 2B, the ICMBot server 104 can receive users' inputs in an input buffer 106 and/or user's posted messages 108 in existing channels in real time; analyze and learn the content of users' posts; understand the post intent; categorize the post into relevant topics; identify whether a user's post included improper information and/or topic in the current conversation channel; find the best-fit conversational channel; and route the user's post to a best-fit conversation channel.

An ICMBot manager 110 can provide a user interface for allowing users to configure and adjust the customized ICMBot settings, including settings to enable/disable the ICMBot 102, settings to adjust a threshold of on-topic scores, and settings for personal characteristics and preferences, for example, configurations, such as conversational platforms and channels, category lists, and authentication information, for example, and criteria. By using the user interface, administrators and users can create, define, customize, and manage settings of the ICMBot 102, and save them into a service profile 112 and a user profile 114.

The service profile 112 provides a configuration file for saving users' configurations related to the ICMBot service. For instance, any universal ICMBot settings and configurations (privacy policies, server settings (centralized, distributed, edged, or local), data structure, threshold of on-topic score, or the like) can be saved into the service profile 112.

An ICMBot data structure 116 provides a data structure called ICMBot data for defining a data structure to track ICMBot related parameters in real time. ICMBot data can include UserID, PostID, PostContent, PostCategory, CurrentChannelID, FittedChannelID, on-topic score, routing, and the like.

An ICMBot criteria database 118 provides set of rules and configurations related to ICMBot criteria, such as off-topic score, routing options (automated rout, display alert, reject/delete the post), and the like.

The user profiles 114 provide a set of user personalized configuration files and related parameters for intelligently routing the posts to fitted channels without manually accepting recommendations.

An ICMBot learner 120 provides a module for learning categories of existing and newly created channels, including private and/or public channels, from posted contents, purpose descriptions of the channels, and other users' reactions to posts made in a given channel. For instance, statistic data indicates that high frequent keywords of “look for opportunities/positions/roles”, “work experience”, “visa status” can be found in posts of a “Job Openings” channel, so it can save such high frequent words into metadata of the “Job Openings” channel.

A channel list 122 provides a set of collection of channels, including channel names; channel IDs, channel descriptions, and the like, in at least one conversational platform. The channel list 122 may be used to learn and screen users' posts for identifying post intents and determining best fitted channel. The channel list 122 may be generated by the ICMBot learner 120 or users by searching available channels.

Channel categories 124 describe a set of categories learned and defined by the ICMBot learner 120 or by the users. Channel categories 124 may be used to calculate on-topic scores in real time, as discussed in greater detail below.

An intent identifier 126 provides a module for identifying the intent of users' inputs on the fly and concluding the topic of the input. For instance, based on the content of the user post, the intent identifier 126 can analyze the keywords and information provided to determine which category or channel the post in a user input buffer might belong. In one example, illustrated below, the post seems to be related to job seeking. The example illustrates how the post can be categorized according to the learned categories by the ICMBot learner 120.

| Post or User Input Buffer | Post | Current | Fitted | On-Topic |
|---|---|---|---|---|
| Content | Category | Channel ID | Channel ID | Score |
| Hi All, I am working as an | NULL | Channel 11: | NULL | NULL |
| Application Developer and | | Prod. Dev. | | |
| have an H1B visa stamped, | | | | |
| looking for US onsite | | | | |
| opportunities and ready for | | | | |
| travel. Please find my details | | | | |
| below: | | | | |
| Total Experience: 7 years | | | | |
| Business Unit: GBS | | | | |
| SkillSet: Java, spring, spring | | | | |
| boot, Microservices . . . | | | | |
| After ICMBot processing: | Job | Channel 11: | Channel 8: Job | 100% |
| | Opportunities | Prod. Dev. | Opportunities | |

Based on the content of the user post, the intent identifier 126 can analyze the keywords and information provided to determine which category the post in a user input buffer (for real-time categorization) or already posted in a channel might belong. In this case, the post seems to be related to job seeking and career opportunities. An on-topic score calculator 128 can use the identified keywords and information to compare the metadata of the current channel and possible intended channels, and then calculate an “on-topic score” accordingly.

The user's post includes information about his work experience, skills, visa status, and their interest in seeking US onsite opportunities. This aligns with the category of “Job Openings,” where individuals typically share details about their professional background and express their interest in finding new job positions or advancing their careers. While the post doesn't explicitly match any other category from the provided list, it's important to note that categorizing posts can sometimes involve interpretation based on context and content. In this case, the user's focus on job-related details makes the “Job Openings” category the most relevant choice.

A best channel mapper 130 provides a module for mapping the best fit conversation channel according to the identified users' intents and inputted topics.

An ICMBot screener 132 provides a module for screening the posts posted contents and others' reactions in multiple conversation channels.

The on-topic score calculator 128 can calculate the on-topic score according matched keywords in metadata of each channel for each screened message. For instance, the on-topic score calculator 128 can use the identified keywords and information to compare the metadata of a current channel and possible intended channels, and then calculate the “on-topic score” accordingly.

A message router 134 provides a module for routing the off-topic messages to the mapped conversation channels with the highest on-topic score and notify the user and related parties. While the above example provided only one matched channel with 100% on-topic score, in some embodiments, multiple channels may be matched with the post and an on-topic score may be provided for each separate possible channel. The message router 134 can choose the channel with the highest on-topic score.

An ICMBot adjuster 136 provides a module for adjusting the ICMBot settings and criteria according to users' feedback and values of the off-topic and on-topic messages.

An ICMBot client 138 provides a conversational application in a client device (computer, mobile phone, wearable device, or the like) for editing users' inputs in the input buffer and sending/posting users' messages to targeted channels in real time.

An input buffer monitor 140 provides a module for monitoring a user's editing buffer when the user is inputting in client side, as described below in reference to the flow chart of FIG. 2.

A channel recommender 142 provides a module for suggesting the mapped conversation channels to deliver the users' message to the mapped channels.

To implement the ICMBot 102, various implementations may be performed. While the below lists several such implementations, in certain embodiments, some or all or additional implementations may be used to provide the ICMBot 102. For example, the intent categories and channel mapping can be defined by identify the various intent categories relevant to the conversation platform (e.g., “Job Posting,” “General Discussion,” “Announcements,” and the like) and the mapping between each intent category and the corresponding channels where the posts should be routed can be determined. A suitable natural language processing (NLP) framework or service that can handle intent recognition, entity extraction, and natural language understanding is selected. A chatbot development framework or platform can be chosen that allows seamless integration with the conversation platform (e.g., Slack API). The ICMBot 102 can be set up as a separate application or service and can be integrated with the conversation platform's API to access incoming messages and respond with routing decisions.

An NLP model can be trained using labeled data to recognize various intent categories in user messages. The model can be fine-tuned based on continuous learning from user interactions and feedback.

The logic for intent categorization can be implemented based on the NLP model's predictions. A routing algorithm can be developed to determine the appropriate channel for each message based on its recognized intent.

In some embodiments, the ICMBot 102 can be configured to automatically move posts to the best-fit channels based on the intent categorization and routing logic. A user-friendly interaction mechanism can be implemented where the ICMBot 102 can engage with users to clarify intent or suggest better channels for their posts. Sers can be allowed to provide feedback on routing decisions to improve the ICMBot's performance. In some embodiments, the system can account for potential errors or misclassifications by the NLP model, and provide fallback mechanisms for human moderators to override the ICMBot's decisions when necessary.

The ICMBot 102 may be continuously improved through regular monitoring of the ICMBot's performance and through the gathering of feedback from users to identify areas of improvement. The NLP model and routing logic can be updated periodically to enhance accuracy and user satisfaction.

By following these implementation steps, organizations can successfully deploy the Intelligent Channel Moderation Bot (ICMBot) in their conversation platform, allowing for more efficient and organized discussions, improved user experience, and enhanced collaboration across channels.

Referring now to FIGS. 2A, these interconnected flow charts show how the modules of the ICMBot server 104 interact with a client 240 that can post messages to a conversation channel platform 220 in one of a plurality of channels, such as channel-1 221, channel-2 222, channel-3 223, channel-i, 224, and channel-N 226. A user 242 can operate a conversational application 244 on a client 240. In this embodiment, client 240 does not include any ICMBot services, applications, modules, or the like. When the user 242 creates a post in the conversational application 244, the user 242 chooses a conversational channel to post the message, such as conversational channel-i 224.

Either periodically, such as hourly, daily, weekly or the like, or as soon as a new message is posted, the ICMBot screener 132 can review the new message (or, in the case of periodical screening, all new messages) and the intent identifier 126 can determine the intent of the message. For instance, based on the content of the user post, the intent identifier 126 can analyze the keywords and information provided to determine which category or channel the post in a user input buffer might belong. Once one or more possible channels are identified for the message, the on-topic score calculator 128 can generate an on-topic score for each of the identified possible channels. The best channel mapper 130 can identify the best channel based on the scores generated by the on-topic score calculator 128 and the message router 134 can ensure the message is either already posted in the correct conversational channel or can move the message into the determined best channel.

The ICMBot can improve during use thereof. For example, the ICMBot adjuster 136 can adjust the ICMBot settings and criteria according to users' feedback and values of the off-topic and on-topic messages. Further, the ICMBot learner 120 can learn categories of existing and newly created channels, including private and/or public channels, from posted contents, purpose descriptions of the channels, and other users' reactions to posts made in a given channel.

Referring now to FIGS. 2B, these interconnected flow charts show how the modules of the ICMBot server 104 interact with a client 220 that can post messages to the conversation channel platform 220 in one of a plurality of channels, such as channel-1 221, channel-2 222, channel-3 223, channel-i, 224, and channel-N 226. A user 202 can operate a conversational application 204 on a client 200. In this embodiment, client 200 includes an input buffer monitor 206 and a channel recommender 208, as described below.

As the user 202 is creating a post in the conversational application 204, the input buffer monitor 206 can share the message content with the intent identifier 126. Like the example above, with reference to FIGS. 2A, the intent identifier 126 can determine the intent of the message. 6 For instance, based on the content of the user post, the intent identifier 126 can analyze the keywords and information provided to determine which category or channel the post in a user input buffer might belong. Once one or more possible channels are identified for the message, the on-topic score calculator 128 can generate an on-topic score for each of the identified possible channels. The best channel mapper 130 can identify the best channel based on the scores generated by the on-topic score calculator 128 and can notify the channel recommender 208 of the best channel so that the user 202 can post the message in the best channel identified by the ICMBot.

Like the above embodiment, the ICMBot can improve during use thereof. For example, the ICMBot learner 120 can learn categories of existing and newly created channels, including private and/or public channels, from posted contents, purpose descriptions of the channels, and other users' reactions to posts made in a given channel.

The ICMBot, as herein described, can provide several advantages, including the following: (1) Automated channel moderation, where the ICMBot automates the process of channel moderation, eliminating the need for manual intervention by administrators or moderators. As a result, the platform can efficiently manage a large number of channels and user posts, ensuring that each message finds its way to the most relevant channel. (2) Improved user experience, where, by accurately categorizing and routing posts, the ICMBot streamlines discussions and ensures that users can easily find and participate in conversations that align with their interests and needs. This leads to a more personalized and enjoyable user experience. (3) Organized channel focus, where the ICMBot helps maintain channel integrity by preventing off-topic or irrelevant posts from cluttering specific channels. This promotes focused discussions and increases the overall organization of the conversation platform. (4) Enhanced collaboration, where, with the ICMBot's assistance, users can connect with like-minded individuals in the appropriate channels, fostering better collaboration and knowledge sharing. Relevant posts reach the intended audience more effectively, encouraging meaningful interactions. (5) Saved time and resources, where the automation provided by the ICMBot reduces the manual effort required for channel moderation, freeing up administrators and moderators to focus on other critical tasks. This efficiency gains result in time and resource savings for the organization. (6) Promoted platform engagement, where, by ensuring that content is appropriately distributed across channels, the ICMBot encourages increased engagement and participation from users. Relevant discussions attract more users, creating a vibrant and active communication platform. Of course, other advantages, not specifically described above, may be realized by the system and methods according to the present disclosure.

### Example Process

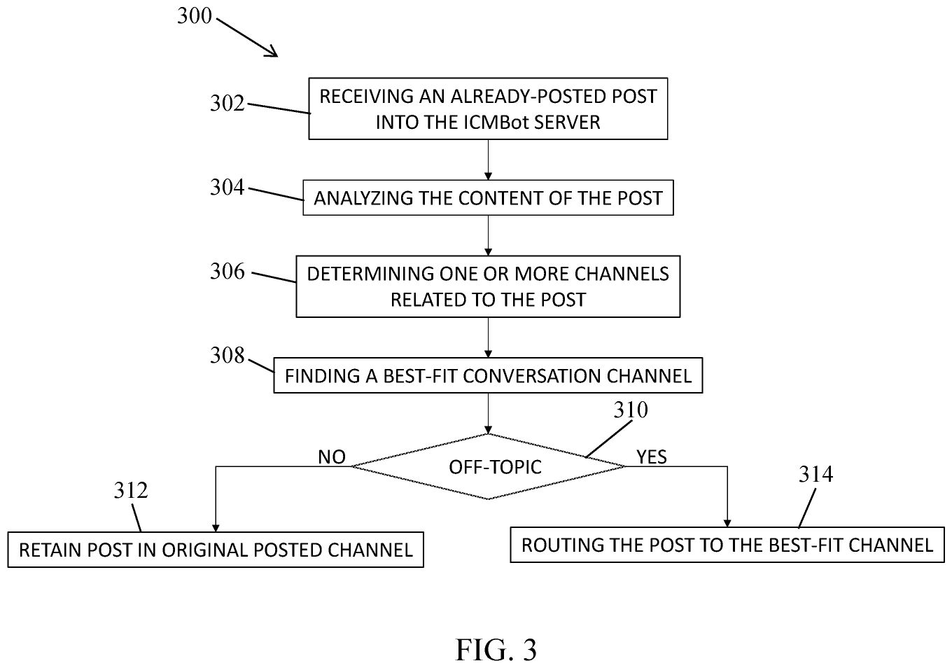

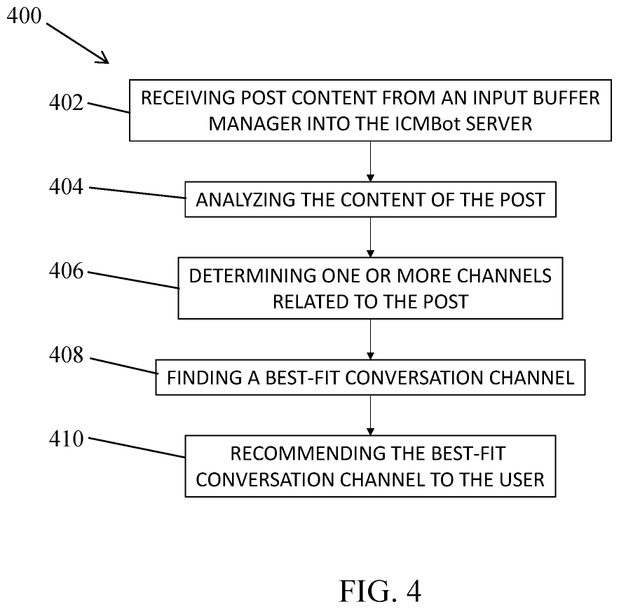

It may be helpful now to consider a high-level discussion of an example process. To that end, FIGS. 3 and 4 present illustrative processes related to the method for managing posts in a conversation platform. Processes 300, 400 are illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 3, block 302 of process 300, can include an act of receiving an already-posted post, posted by a user to a first conversational channel, into an intelligent channel moderation bot (ICMBot) screener of an ICMBot server. The process 300 can further include block 304 for the act of analyzing content of the post. Block 306 provides an act for determining one or more channels related to the content of the post. Block 308 provides an act for finding a best-fit conversation channel from the determined one or more channels. In block 310, a determination is made to determine whether the post is already in the best-fit conversational channel or not. If the post was initially posted in the best-fit conversational channel, it is retained therein in block 312. In block 314, if the post is not already in the best-fit conversational channel, the post is routed from the posted conversational channel into the best-fit conversational channel.

Referring to FIG. 4, block 402 of process 400, can include an act of receiving, into an intelligent channel moderation bot (ICMBot) screener, a post content from an input buffer manager of a user in real time while the user is creating the post. The process 400 can further include block 404 for the act of analyzing content of the post. Block 406 provides an act for determining one or more channels related to the content of the post. Block 408 provides an act for finding a best-fit conversation channel from the determined one or more channels. In block 410 the best-fit conversation channel is recommended to the user prior to the user posting the post into the conversation platform.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

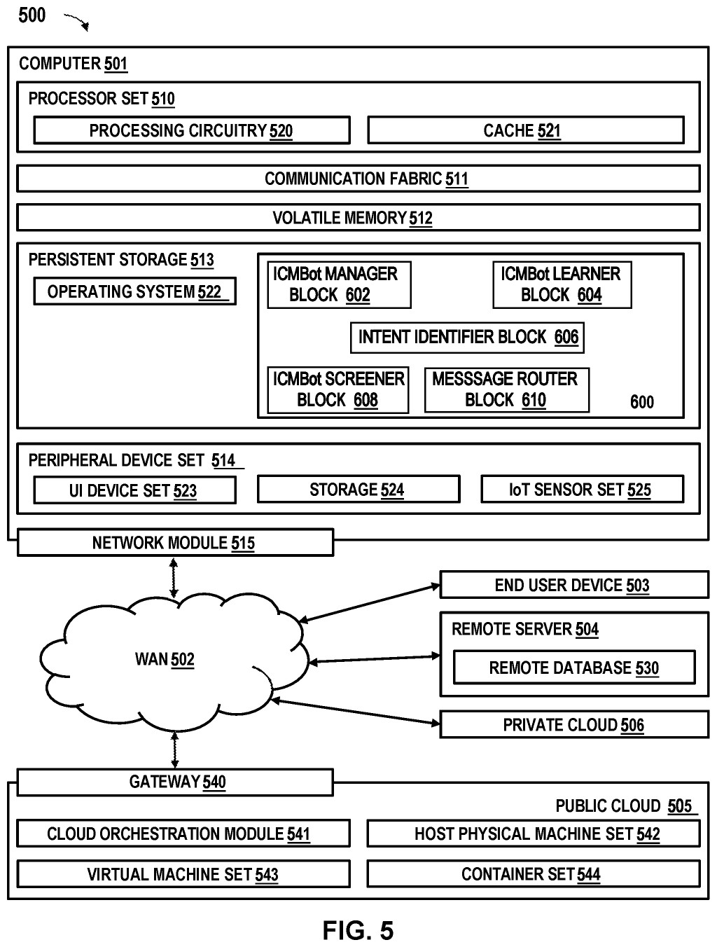

Referring to FIG. 5, computing environment 500 includes an example of an environment for the execution of at least some of the computer code involved in performing the inventive methods, including an ICMBot code block 600, which can include an ICMBot manager block 602, a ICMBot learner block 604, an intent identifier block 606, an ICMBot screener block 608, and a message router block 610. In addition to block 600, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 600, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 600 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 600 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for managing posts in a conversation platform, comprising:
receiving a post, from a first conversational channel, into an intelligent channel moderation bot (ICMBot) screener of an ICMBot server;
analyzing content of the post;
determining one or more channels related to the content of the post;
finding a best-fit conversation channel from the determined one or more channels;
retaining the post in the best-fit conversational channel when the first conversational channel is the best-fit conversational channel; and
routing the post from the first conversational channel into the best-fit conversational channel when the first conversation channel is not the best-fit conversational channel.

2. The computer-implemented method of claim 1, wherein the receiving the post comprises receiving the post or a plurality of new posts into the ICMBot screener at a predetermined interval.

3. The computer-implemented method of claim 1, further comprising determining an intent of the post by analyzing keywords and information provided in the post to determine which category or channel the post belongs.

4. The computer-implemented method of claim 1, further comprising calculating an on-topic score according matched keywords between metadata of each conversational channel and the post.

5. The computer-implemented method of claim 4, further comprising routing, when the post is determined to be off-topic, the post to a mapped conversation channel having a highest on-topic score.

6. The computer-implemented method of claim 5, further comprising notifying a user of the post being routed to the mapped conversation channel.

7. The computer-implemented method of claim 1, further comprising adjusting settings and criteria of the ICMBot server according to feedback of users and values of off-topic and/or on-topic posts.

8. The computer-implemented method of claim 1, further comprising learning categories of existing and newly created channels from posted content, purpose descriptions of conversational channels, and reaction of other users.

9. The computer-implemented method of claim 1, further comprising screening content and other users' reactions in multiple ones of a plurality of conversational channels.

10. The computer implemented method of claim 1, further comprising receiving an input from administrators and other users to configure and adjust settings and criteria of the ICMBot server.

11. A computer-implemented method for managing posts in a conversation platform, comprising:
receiving, into an intelligent channel moderation bot (ICMBot) screener, a post content from an input buffer manager in real time while a post is being created;
analyzing a content of the post;
determining one or more channels related to the content of the post;
finding a best-fit conversation channel from the determined one or more channels; and
recommending the best-fit conversation channel to a user prior to the user posting the post into the conversation platform.

12. The computer-implemented method of claim 11, further comprising analyzing keywords and information provided in the post to determine an intent of the post.

13. The computer-implemented method of claim 12, further comprising calculating an on-topic score according matched keywords between metadata of each conversational channel and the post.

14. The computer-implemented method of claim 11, further comprising learning categories of existing and newly created channels from posted content, purpose descriptions of conversational channels, and reaction of other users.

15. The computer-implemented method of claim 11, further comprising screening content and other users' reactions in multiple ones of a plurality of conversational channels.

16. The computer implemented method of claim 1, further comprising receiving an input from administrators and other users to configure and adjust settings and criteria of the ICMBot server.

17. The computer-implemented method of claim 11, further comprising adjusting settings and criteria of the ICMBot screener according to feedback from other users and values of off-topic and/or on-topic posts.

18. A system comprising:
a processor;
a data bus coupled to the processor;
a memory coupled to the data bus; and
a computer-usable medium embodying a computer program code, the computer program code comprising instructions executable by the processor and configured to:
receive a post that is either (1) an already-posted post, posted to a first conversational channel, or (2) a pre-posted post, based on content received from an input buffer manager in real time while a post is being created, into an intelligent channel moderation bot (ICMBot) screener of an ICMBot server;
analyze content of the post;
determine one or more channels related to the content of the post;
find a best-fit conversation channel from the determined one or more channels;
retain the already-posted post in the best-fit conversational channel when the first conversational channel is the best-fit conversational channel;
route the already-posted post from the first conversational channel into the best-fit conversational channel when the first conversation channel is not the best-fit conversational channel; and
recommend the best-fit conversation channel to a user prior to the user posting the pre-posted post into a conversation platform.

19. The system of claim 18, wherein the instructions are further configured to analyze keywords and information provided in the post to determine an intent of the post.

20. The system of claim 19, wherein the instructions are further configured to calculate an on-topic score according matched keywords between metadata of each conversational channel and the post.
